(19) United States
(12) Patent Application Publication
(10) Pub. No.: US 2026/0116256 A1
(43) Pub. Date: Apr. 30, 2026

(54) MODULAR SCALABLE PLATFORM ZONAL ARCHITECTURE FOR ELECTRIC VEHICLE

(71) Applicant: Rivian IP Holdings, LLC, Irvine, CA (US)

(72) Inventors: Sanjeewa Keven SUGATAPALA, Long Beach, CA (US); Kyle LOBO, Westchester, CA (US); Glenn Morris FEINBERG, Carlsbad, CA (US); Joseph Daniel HIMMELHEBER, Redondo Beach, CA (US); Michael HONG, Irvine, CA (US); Long Phi HUYNH, Brea, CA (US); Frederik Francois BOTES, Ontario, CA (US); Ramachandra VANNALA, Fremont, CA (US)

(21) Appl. No.: 19/216,577

(22) Filed: May 22, 2025

Related U.S. Application Data
(60) Provisional application No. 63/712,996, filed on Oct. 28, 2024.

(51) Int. Cl. B60L 58/20; B60L 50/60; B60L 53/10; B60L 53/22; B60L 53/62

(52) U.S. Cl. CPC B60L 58/20; B60L 50/66; B60L 53/11; B60L 53/22; B60L 53/62; B60L 2210/10; B60L 2210/30

(57) ABSTRACT

An advanced integrated energy storage and distribution system for electric vehicles is disclosed. The system incorporates a rear centralized zonal architecture, event-driven power sourcing, integrated vehicle core hardware controls, a high voltage pack with low voltage body controls, a functionally redundant low voltage architecture, and DCFC split contactor control for enhanced safety, among other things. This comprehensive system significantly reduces complexity, improves packaging, enhances reliability, increases safety, and provides functional redundancy compared to conventional designs. The integration of these innovations results in a highly efficient, safe, and cost-effective power management solution for electric vehicles.

### CROSS-REFERENCE TO RELATED APPLICATIONS

The present application claims the benefit of U.S. Provisional Application No. 63/712,996, entitled “MODULAR SCALABLE PLATFORM ZONAL ARCHITECTURE FOR ELECTRIC VEHICLE”, filed Oct. 28, 2024, the entirety of which is incorporated herein for reference.

### INTRODUCTION

This application is directed to power and feature management systems for electric vehicles, such as zonal integrated energy storage and distribution architecture that combines multiple features associated with an electrified vehicle.

### SUMMARY

The disclosed subject matter provides for zonal architecture for power distribution and other designs thereof that may allow for redundancy in power distribution and feature functionality.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates an exemplary overhead view of a vehicle with zonal power distribution as described herein.

FIG. 1B illustrates an exemplary side view of a vehicle with zonal power distribution as described herein.

FIG. 2A illustrates an example block diagram of a system with zonal power distribution as described herein.

FIG. 2B illustrates an example block diagram of a system with zonal power distribution as described herein.

FIG. 2C illustrates an example detailed portion of the block diagram of FIG. 2B.

FIG. 2D illustrates an example detailed portion of the block diagram of FIG. 2B.

FIG. 3 illustrates an example block diagram of a system with zonal power distribution as described herein.

FIG. 4 illustrates an example block diagram of a system with zonal power distribution as described herein.

FIG. 5 illustrates an example method for implementing event-driven power sourcing.

FIG. 6 illustrates an exemplary block diagram of components or functionality of a vehicle.

FIG. 7 illustrates an example method for implementing split contactor control.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Conventional electric vehicle power systems often use distributed components, leading to increased complexity, wiring, and reduced reliability. There is a need for more integrated and centralized architectures to improve efficiency, reduce costs, enhance safety, and provide functional redundancy. Current systems often struggle with optimal power distribution, safety during charging, and efficient packaging of components. The disclosed subject matter may address these challenges through a comprehensive, integrated approach.

The disclosed subject matter introduces an advanced integrated energy storage and distribution system for electric vehicles, featuring multiple innovations. The multiple innovations may include a rear centralized zonal architecture designed for low-cost electric vehicles, event-driven power sourcing to different vehicle zones, and integrated vehicle core hardware controls for managing the high voltage battery and critical core functions. The system may incorporate a high voltage pack with low voltage body controls, a functionally redundant low voltage architecture between the vehicle's left and right sides, or direct current fast charging (DCFC) split contactor control for enhanced safety. These innovations may reduce complexity, improve packaging, enhance reliability, increase safety, or provide functional redundancy when compared to conventional designs.

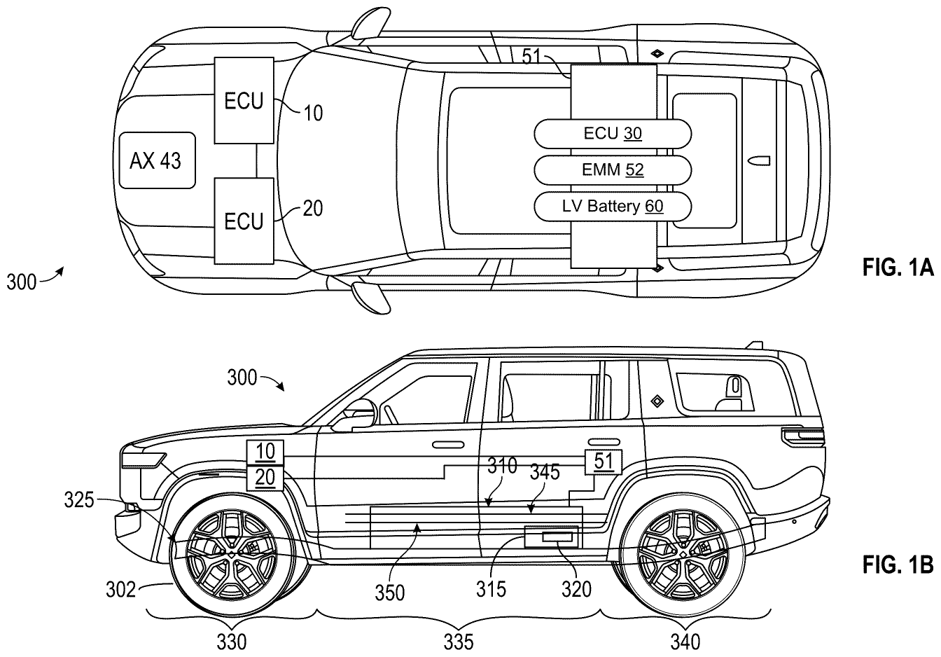

FIG. 1A illustrates an example overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), power management compartment 51, axial flux motor 43, or low voltage (LV) battery 60 (e.g., 12V battery), among other things. Zones associated with each ECU may be based on proximity. In an example, if components are geographically closer to a west zone then those components may be connected with ECU 20, and if components are geographically closer to ECU 10 then those components may be connected with ECU 10. As further described herein, ECU 10 may operate components on a first side of a longitudinal axis of vehicle 300, while the ECU 20 may operate components on a second side of the longitudinal axis. The longitudinal axis may be defined as an imaginary line running from the front of vehicle 300 to the rear along its center, dividing vehicle 300 into the first (e.g., left) and second (e.g., right) sides. ECU 30 may operate components at the rear of vehicle 300. ECU 30 may be located within power management compartment 51.

Power management compartment 51 may include ECU 30, energy management module (EMM) 52, or LV battery 60 (e.g., 9 volts (V) to 16V), among other components. Power management compartment 51 may be a power management system located in a rear of vehicle 300, such as under the second row seat or trunk of vehicle 300. Power management compartment 51 may be the volume of a traditional gas tank and package multiple components as disclosed herein. Power management compartment 51 components may include ECU 30 with left and right MCUs (e.g., MCU 65 or MCU 66), a DC-DC converter (e.g., DCDC 50), LV battery 60, or an isolation switch (ISOSW) (e.g., fault isolation system 11), among other things. DCDC 50 may be located within EMM 52. ECU 30 may integrate battery management system (BMS) and zonal control functions, managing power distribution between the DC-DC bus and battery bus. With the current architecture there may be more immediate control of rear functionality. Power management compartment 51 may connect with ECU 10 and ECU 20, forming the backbone of the vehicle's power architecture. This design may reduce high current feeds from 7 or more in other architectures to just 3, for example, in the disclosed architecture, while eliminating the need for diode ORing, among other things. Power management compartment 51 may provide end-to-end functional redundancy and may enable simplified LV battery management through a single battery feed. This approach may allow for more efficient packaging and reduced system complexity.

FIG. 1B illustrates an example side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. As further described herein, ECU 10 (also may be referred to herein as east zone controller—EZC 10), ECU 20 (also may be referred to herein as west zone controller—WZC), or ECU 30 (also may be referred to herein as south zone controller—SZC) may be communicatively connected with or have power distributed with each other and may be functionally redundant for power or other operations of electronic components of vehicle 300.

In one or more implementations, vehicle 300 may be an electric vehicle having one or more electric motors that drive wheels 302 of the vehicle 300 using electric power from HV battery pack 310. In one or more implementations, vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 300 may be implemented as a truck (e.g., a pickup truck) having a battery pack 310. As shown, HV battery pack 310 may include one or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 1B, vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portions 330, center body portion 335, or the rear portion 340). As shown, HV battery pack 310 may include or be electrically coupled with one or more one busbars (e.g., one or more current collector elements). In the example of FIG. 1B, vehicle 300 includes a first busbar 345 and a second busbar 350, either or both of which may include electrically conductive material to connect or otherwise electrically couple battery module(s) 315 or the battery cell(s) 320 with other electrical components of vehicle 300 to provide electrical power to various systems or components of vehicle 300.

In other implementations, vehicle 300 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, or any other movable apparatus having a battery pack 310 (e.g., that powers the propulsion or drive components of the moveable apparatus).

The disclosed multi-zonal architecture may allow for reduced wiring when compared to other architectures. Shorter wires may provide for less mass and therefore vehicle 300 may weigh less. While wire length generally may not significantly affect cost for small gauge wires, it may influence the overall mass and flexibility of the harness. Longer wires may increase harness bulk, potentially complicating installation due to reduced flexibility.

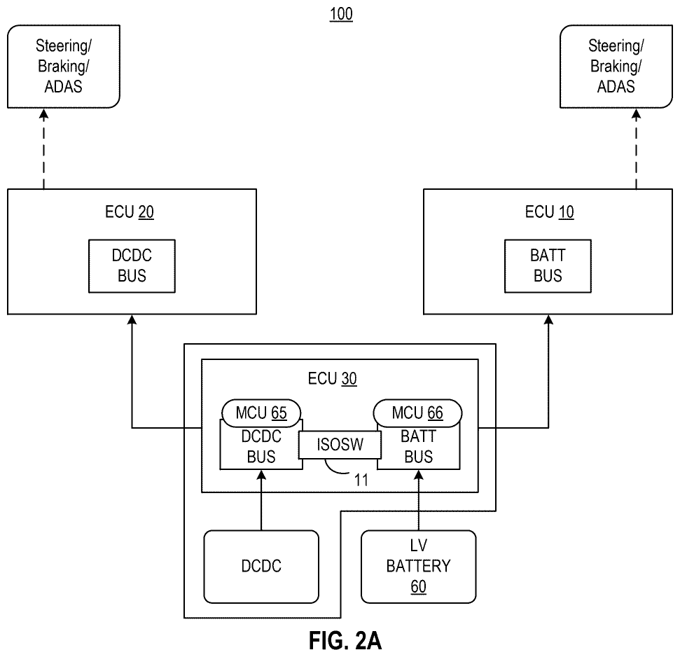

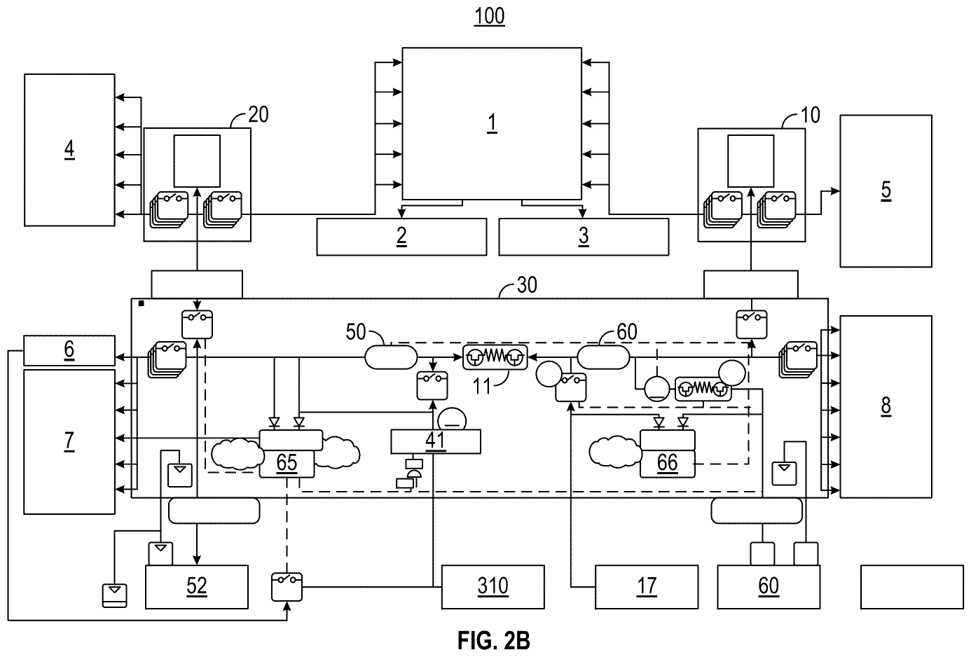

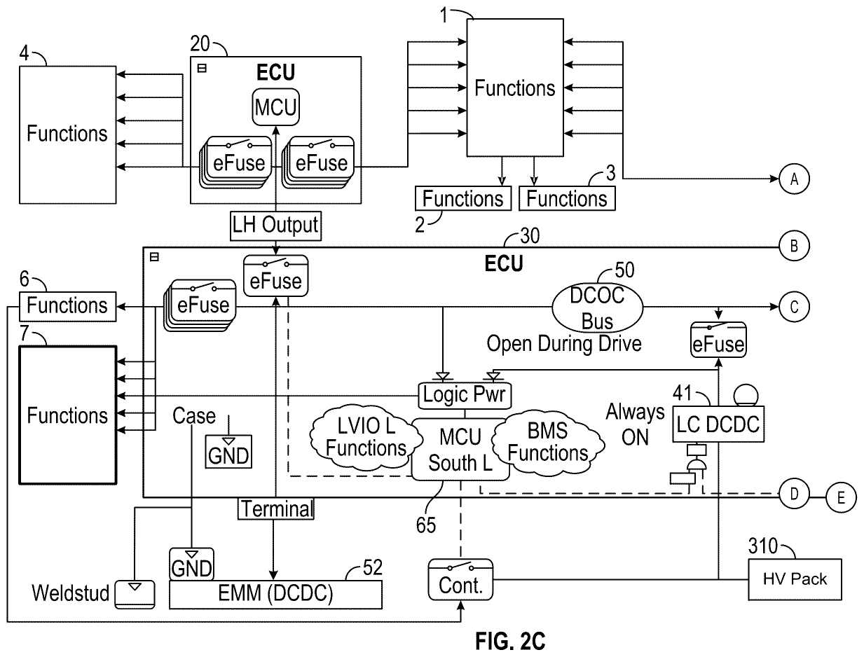

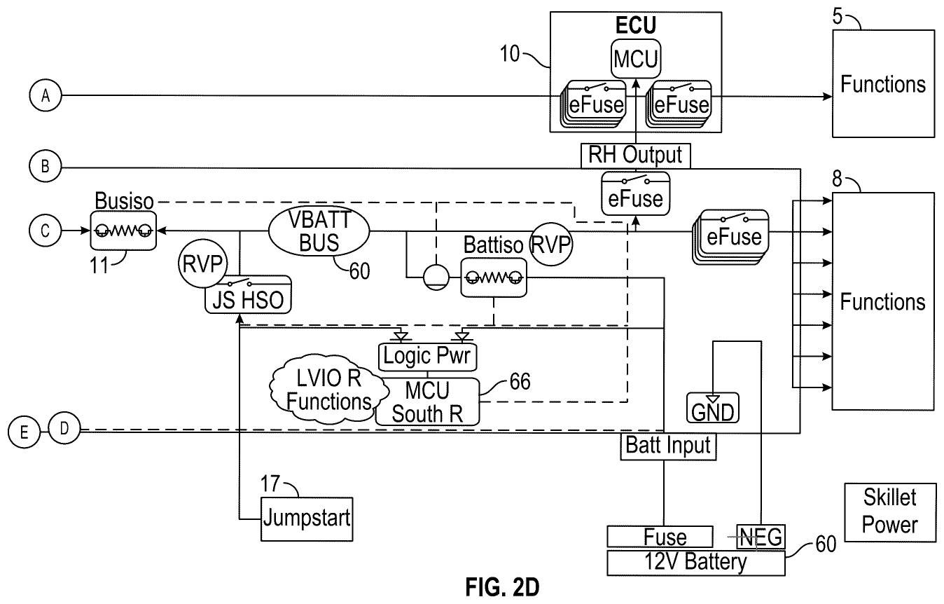

FIG. 2A and FIG. 2B illustrate exemplary block diagrams of system 100 that may include a plurality of ECUs of vehicle 300. An ECU is an embedded system that may control one or more of the electrical systems or subsystems in a vehicle, such as steering, breaking, advanced driver assistance system (ADAS), or the like. The positioning and connections of ECU 10, ECU 20, or ECU 30 may provide for a level of redundancy for faults, which may be caused by collisions or other malfunctions. The design of system 100 may allow vehicle 300 to safely operate for a period after the fault, such as being able to drive vehicle 300 (e.g., steer, brake, or accelerate) to a safe position off of a roadway or being able to operate electronic controlled functions (e.g., door latches) of vehicle 300, among other things. As shown, ECU 10, ECU 20, or ECU 30 may be connected with DCDC 50 (also referred herein as DCDC bus 50) to operate DCDC loads and a low voltage (LV) battery 60 (e.g., 9V-16V battery or LV battery bus 60) to operate LV battery loads.

There may be different types of operations such as post-crash operation, sleep operation, jumpstart operation, manufacturing power operation, DCDC fault operation, LV battery fault operation, or normal operation associated with driving, among others. FIG. 2B illustrates an exemplary block diagram of system 100 in normal operation associated with driving. FIG. 2C and FIG. 2D are zoomed in portions of system 100 of FIG. 2B, with example information regarding currents, voltages, or other information. In an example, one or more ECUs (e.g., ECU 30) may include a fault isolation system 11. Fault isolation system 11 may include an isolation switch. In some configurations, in consideration of safety, only one ECU (e.g., ECU 30) may include fault isolation system 11. There may be a common bus that allows for bidirectional power to be transmitted to and from LV battery 60 that may be a function of using fault isolation system 11. In the event of a failure of the DCDC 50 (e.g., within EMM 52) or LV battery 60, the common bus will retain operation (e.g., will be available).

With continued reference to FIG. 2B through 2D, each ECU may have on or more dedicated functions that may be powered by DCDC 50, LV battery 60, or LV DCDC 41. ECU 10 may operate or connect with (e.g., communication or power) functions 1, functions 2, functions 3, and functions 5. Functions 1 may include functions such as first row universal serial bus, or electronic stability program (ESP), among other things. Functions 2 may include functions such as right door latch, passenger seat motor, right headlamp, alarm module, or frunk latch, among other things. In this example, functions 1, functions 2, functions 3, or functions 5 of ECU 10 may be powered by DCDC 50 (which may be the primary power) or LV battery 60 (which may be the secondary power). ECU 10 may be located on the right front of vehicle 300 and therefore may operate functions primarily for the right portion of vehicle 300.

As shown in FIG. 2B, ECU 20 may operate functions 1, functions 2, functions 3, or functions 4. Functions 1 may include functions such as front suspension valves, or autonomy control module, among other things. Functions 4 may include functions such as steering angle sensor, front wiper motor, left door latches, left headlamp, exterior near field communication (NFC), or on-board diagnostics (OBD) port, among other things. Functions 1 or functions 2 may include functions such as electric power assisted steering (EPAS), charge port door, interior NFC, or electric powered assisted breaking, among other things. In this example, functions 1, functions 2, functions 3, or functions 4 of ECU 20 may be powered by DCDC 50 (which may be the primary power) or LV battery 60 (which may be the secondary power). ECU 20 may be located on the left front of vehicle 300 and therefore may operate functions primarily for the left portion of vehicle 300.

As shown in FIG. 2B, ECU 30 may operate functions 6, functions 7, functions 8, and jumpstart functions. ECU 30 may be connected with jumpstart access 17. Jumpstart access 17 may allow an external power source (e.g., jumpstart pack) to connect with ECU 30 in order to jumpstart electronic functions of vehicle 300, such as when LV battery 60 is depleted. As further described herein, jumpstart access 17 may have multiple routes. Functions 6 may include functions such as main contactor or DCFC contactor. Functions 7 or functions 8 may include functions such as rear vehicle access system sensors, liftgate latch, trailer brake, right lamp rear, left lamp rear, right trailer brake lamp, rear suspension valves, DCDC logic power, BMS voltage/isolation monitoring, park lock, HV pack shunt monitor, radio farm, charge port PC/IO, rear radar, or ethernet components, among other things. In this example, functions 6, functions 7, or functions 8 of ECU 30 may be powered by DCDC 50 (which may be the primary power) or LV battery 60 (which may be the secondary power). ECU 30 may be located on the rear of vehicle 300 (e.g., under a rear seat) and therefore may operate functions primarily for the rear portion of vehicle 300.

System 100 may include a battery management system. The BMS may be located at or near HV battery pack 310, which DCDC 50 converts the HV DC to a lower voltage, such as 14V. LV DCDC 41 may help reduce the need for LV battery 60 for some operations, such as when vehicle 300 is in standby mode (e.g., parked). It is contemplated that the functions disclosed herein (e.g., functions 1 through functions 8) may be controlled by other ECUs or powered by any of the listed power sources.

### Rear Centralized Zonal Architecture for Vehicles

This electric vehicle design may incorporate a rear centralized zonal architecture, featuring an ECU 30 (e.g., south zone controller (SZC)) housed in a protected rear centralized zonal architecture with a “treehouse” structure (e.g., power management compartment 51) in a crash protected area of vehicle 300, such as beneath the second row seat. A crash-protected area of a vehicle refers to specific zones within the vehicle that are designed to offer the highest level of protection during a collision. ECU 30 may act as the core of the electrical system of vehicle 300, integrating high voltage battery management, LV battery management, power distribution control, or rear body control functions. This approach may significantly reduce wiring complexity by decreasing the number of high current power feeds from seven or more to just three main feeds, for example: the DC-DC converter output to ECU 30, ECU 30 to ECU 20, and ECU 30 to ECU 10. This reduction in wiring not only decreases the overall weight of vehicle 300 but may simplify the manufacturing process, enhance reliability by reducing potential failure points, or minimize electromagnetic interference issues. The disclosed architecture may provide for currents going through ECU 10 and ECU 20 to be significantly less than other systems, and therefore there may be the use of significantly more connectors than terminals.

The rear centralized zonal architecture may provide enhanced crash safety by shielding critical components from front, rear, or side impacts. This centralized location of a power management compartment reduces the likelihood of damage to multiple systems simultaneously in severe crash scenarios, potentially improving occupant safety and post-crash response capabilities. The centralized power management compartment may include power management compartment 51 or LV battery 60, among other things. Power management compartment 51 may be in an area reinforced with strong structural components to absorb and dissipate impact energy, minimizing injury to occupants (and secondarily power management compartment 51).

Thermal management may be efficient through the centralization of high-power components. A single, high-efficiency cooling loop may service the high-power components in Power management compartment 51, enhancing overall cooling efficiency and reducing the complexity associated with multiple separate cooling systems. For example, a location under the second row seat may allow for airflow management, contributing to overall thermal management without significant additional hardware.

Serviceability may be enhanced with core components accessible from a single location, simplifying maintenance and repairs. As disclosed herein, the centralized serviceability allows for modular design with components designed as replaceable modules for simpler maintenance and potential upgrades. By relocating components traditionally placed in the front of the vehicle (e.g., LV battery 60 or DCDC 50) to the rear power management compartment 51, this architecture may allow for a larger front trunk area, enhancing the utility of vehicle 300 and offering more flexibility in front-end design.

### Event Driven Power Sourcing to Vehicle Zones for Electric Vehicles

With reference to FIG. 2B, building upon the centralized architecture, the disclosed subject matter implements an event-driven power sourcing system. This approach allows the ECU 30 to dynamically route power from DCDC 50 (e.g., from the high voltage battery) or LV battery 60 to different vehicle zones (e.g., ECU 10 or ECU 20) based on operating conditions or fault scenarios. The event-driven power sourcing may be implemented through one or more isolation switches (e.g., fault isolation system 11) controlled by ECU 30. In the event of a localized fault, the system 100 can isolate the affected area while maintaining power to critical systems in other zones. This granular control over power distribution significantly enhances the ability of vehicle 300 to continue operating safely even when parts of the electrical system are compromised. For example, if a short circuit is detected in the front left door, the system 100 can immediately isolate that zone while maintaining power to critical systems like steering, braking, or lighting. This prevents a localized issue from cascading into a vehicle-wide power loss.

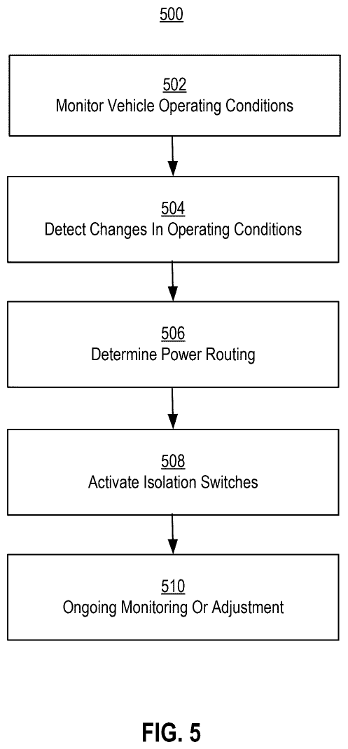

FIG. 5 illustrates an example method 500 for implementing event-driven power sourcing in a vehicle electrical system as disclosed herein. At step 502, vehicle operating conditions may be monitored. This may involve implementing a network of sensors throughout vehicle 300, developing algorithms to interpret sensor data in real-time, and creating a prioritized list of vehicle states and corresponding power needs. At step 504, the changes in operating condition or fault scenarios are detected. This may include implementing fault detection algorithms for each vehicle zone (e.g., associated with ECU 10, ECU 20, or ECU 30), developing a system to quickly identify and localize electrical faults, and creating a hierarchy of fault severity to guide system responses.

At step 506, optimal power routing based on detected conditions may be determined. This may involve decision-making algorithms that balance safety, performance, or efficiency, implementing machine learning techniques to continually optimize power routing strategies, or creating scenarios for different driving conditions and fault types. ECU 30 may dynamically determine which zones or corresponding functions may be provided power to operate. At step 508, appropriate isolation switches may be activated (e.g., by ECU 30—rear zonal controller) to implement the determined power routing. There may be a network of high-speed, reliable isolation switches as disclosed herein to implement redundancy in power paths, and fail-safe mechanisms may be used to ensure safe power states in varying scenarios.

At step 510, there may be ongoing monitoring and adjustment as necessary. This may include implementing a feedback loop to continually assess the effectiveness of power routing decisions, developing self-diagnostic capabilities to identify any issues with the power routing system itself, or creating logging systems to record power routing decisions for later analysis and improvement. This method may allow for rapid reconfiguration of the power architecture in response to various scenarios. For example, in a side impact scenario, the system 100 may isolate power on the impacted side while maintaining power to critical systems on the opposite side.

Various protection schemes may be implemented, including over-current protection on main feeds, under-voltage load shedding, or isolation switch control for major faults. These protection schemes work in concert to ensure the safety and reliability of the electrical system under operating conditions. The over-current protection may prevent damage from short circuits or excessive loads, the under-voltage load shedding may help maintain power to critical systems in low-battery situations, and the isolation switch control may provide granular management of power distribution in fault scenarios. Load shedding may be hardware based and shed based on meeting a threshold. The shedding may be used to preserve critical functionality and there may be multiple tiers of loads. In an example, a first tier (e.g., most critical) may be functions associated with safety of user (e.g., steering, breaking, or ADAS), a second tier may include vehicle door latches, a third tier may include functions associated with customer satisfaction (e.g., HVAC, USB power outlets); and a fourth tier (least critical) may include seat heaters, puddle lighting, or cabin lighting. In an example, there may be a use of software based load shedding for more non-critical loads (e.g., third tier or fourth tier functionality).

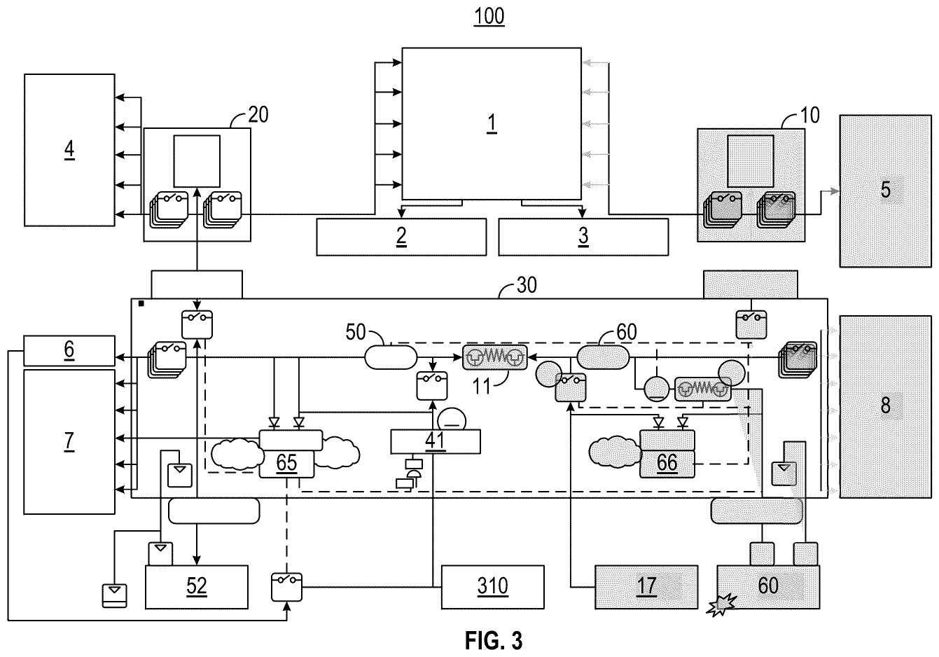

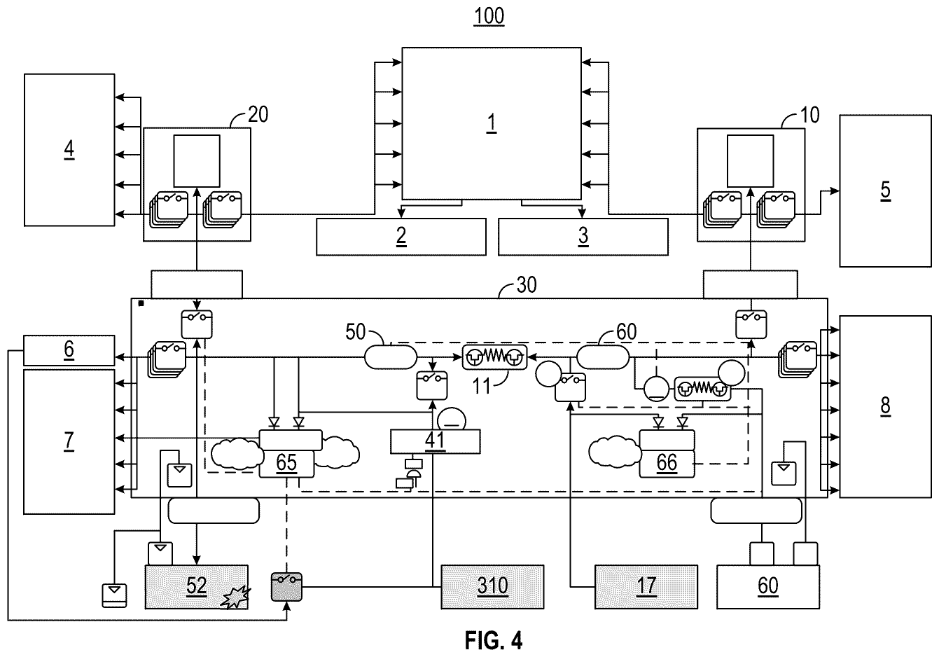

FIG. 2B, FIG. 3, and FIG. 4 illustrate different scenarios for various protections schemes. In FIG. 3, there may be a Vbatt fault and DCDC 50 may be the primary bus that is supplying power to functions while LV battery 60 and associated Vbatt loads (as grayed with regard to Vbatt bus 60) may not have access to power. It is contemplated that if there is a fault with DCDC 50 then DCDC bus 50 may be shutoff and Vbatt bus 60 may power associated functions. In FIG. 4, there may be a crash related fault and DCDC 50 does not supply power but LV battery 60 may supply power to selected functions throughout ECU 30, ECU 10, or ECU 20, using multiple buses and associated loads that are powered down (e.g., as grayed—EMM 52 or LV DCDC 41) may not have access to power. There are other scenarios that may be considered. In another example scenario associated with vehicle 300 being in a sleep state, LV DCDC 41 may be called on to power selected functions (e.g., monitoring or powering of selected fuses, MCUs, communication systems, etc.).

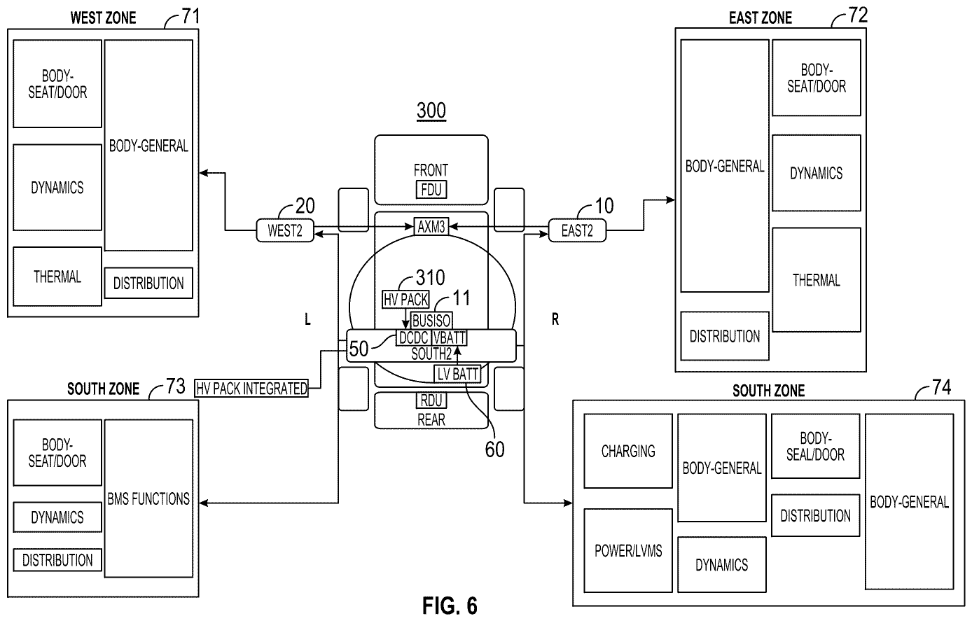

FIG. 6 illustrates an exemplary block diagram of components or functionality of vehicle 300, which may have similar connections or functions as shown in FIG. 2A or FIG. 2B. EZC functions 72 may include sensor control module functions, charge control module functions, body/power control module functions, temperature management control module functions, intelligent battery sensor functions, vehicle driving control functions, or driver control module functions, among other functions which may be associated primarily with the right side of vehicle 300. WZC functions 71 may include sensor control module functions, charge control module functions, body/power control module functions, temperature management control module functions, vehicle driving control functions, or driver control module functions, among other functions which may be associated primarily with the left side of vehicle 300. SZC functions 73 or SZC function 74 may include body control module functions, vehicle driving control module functions, or temperature/body/power control module functions, among other functions which may be associated primarily with the rear of vehicle 300. Some or all B pillar rear functions may be controlled by ECU 30 (e.g., SZC).

### Integrated Vehicle Core Hardware Controls (High Voltage Battery and Critical Core Functions) for Vehicles

The disclosed subject matter may include integration of high-voltage battery management, LV power management, and critical vehicle controls into a single module, such as ECU 30. This integrated approach may affect vehicle design and performance. In a first aspect, there may be the reduction in component count. By consolidating multiple functions into one module, the total number of components in the vehicle decreases, simplifying the bill of materials and assembly process. This may reduce complexity and enhances the overall reliability of the system by minimizing potential failure points.

In addition to reducing components, the integration may lead to simplified interfaces. Fewer inter-component connections may mean there are fewer opportunities for physical connector issues, electromagnetic interference (EMI), or communication failures. This streamlining of connections may contribute to greater reliability and reduce the risk of system malfunctions caused by faulty interfaces.

Another aspect may be enhanced diagnostic capabilities. By integrating multiple systems, ECU 30 may perform comprehensive diagnostics, potentially identifying and addressing failures before they occur. The access to data by ECU 30 from various vehicle 300 systems may enable ECU 30 to detect patterns and correlations that may be overlooked when systems operate independently.

Eliminating physical connections between previously separate modules reduces potential failure points, as each connection is a possible weak point in the system. Fewer connections inherently boost overall dependability, ensuring that the vehicle 300 operates more consistently.

This approach may allow for optimized power management. With control over both high and low voltage systems, ECU 30 may implement more sophisticated power management strategies, improving the overall efficiency of vehicle 300. This may enable vehicle 300 to make decisions that extend vehicle range and battery life, contributing to a more efficient and reliable power management system.

With reference to FIG. 2B, ECU 30 may utilize a dual microcontroller architecture, such as MCU 65 and MCU 66, which may allow for enhanced safety and functional separation, with first MCU 65 manages high voltage battery management, contactor control, or thermal monitoring, while second MCU 66 manages low voltage (LV) power, DC-DC control, body control functions, or electronic parking brake control. Each microcontroller can be optimized for its specific tasks, potentially improving overall system performance. Critical functions can be backed up between the two microcontrollers, enhancing system reliability. By separating high voltage functions (e.g., functions 6 or functions 7) and low voltage functions (e.g., functions 8), the system can maintain critical low voltage functions even if there is an issue with the high voltage system.

The rear centralized zonal architecture implements a functionally redundant low voltage architecture between the first side (e.g., west side of vehicle 300) and a second side (e.g., cast side of vehicle 300), which may ensure that many of the critical functions have a complementary method of execution powered by the opposite bus. This may enhance reliability, reduces wiring and allowing for flexible power management, and an improvement in fault tolerance.

This functionally redundant architecture represents a significant departure from traditional automotive electrical systems. By creating two independent but interconnected power networks, the vehicle gains a level of resilience to electrical faults. For instance, if a wiring harness is damaged on one side of the vehicle, critical systems can immediately switch to drawing power from the unaffected side without interruption in vehicle operation or safety systems. The integrated ECU 30 offers several advanced features designed to enhance vehicle performance and safety. It includes dual microcontrollers to provide redundancy, ensuring the system continues to function reliably in case of a failure. ECU 30 may be equipped with a direct connection to the LV battery 60, enabling enhanced monitoring and more precise control of power usage. Additionally, ECU 30 features integrated DC-DC converter 50 control, allowing for efficient management of power conversion between voltage levels. High-side and low-side drivers may be included for more precise control of contactors, ensuring safe and efficient power distribution. Furthermore, ECU 30 may provide interfaces for external sensors, such as pressure sensors used to detect thermal runaway events, which contribute to increased safety and system diagnostics.

High Voltage Pack with Low Voltage Body Controls

The disclosed rear centralized zonal architecture that includes high voltage (HV) pack 310 with low voltage body controls is a design that integrates rear vehicle functions, creating a consolidated “rear zone” within vehicle 300. This approach may streamline the control systems for vehicle functionalities, such as lighting, sensors, or other electronic components.

One of the advantages of this integration may be related to packaging. By embedding low voltage body controls directly into the HV pack 310, the need for separate control modules is eliminated, saving both space and weight. This not only allows for a more compact vehicle design but also may improve aerodynamics and maximize the utilization of interior space, contributing to overall vehicle efficiency. Additionally, this integration may simplify wiring by keeping rear wiring contained within the rear zone of vehicle 300. This may reduce the number of circuits routed through areas such as door sills, which not only cuts down on the complexity of the wiring harness but also may improve the vehicle's resistance to environmental factors like water ingress.

Another consideration is efficient power distribution. By centralizing power distribution from the rear seat outward, the electrical architecture of vehicle 300 may be simplified, and power losses caused by long cable runs are minimized. This more direct distribution scheme may improve energy efficiency. Furthermore, the integration of these systems may result in a cost reduction by decreasing the number of individual components and simplifying the assembly process. Fewer components mean a reduced need for supplier management and inventory control, leading to lower production or operational costs.

The design may also contribute to enhanced thermal management. Since the low voltage controls may be integrated into the HV pack 310, they can share the existing thermal management system of HV pack 310, therefore reducing or eliminating the need for separate cooling systems for body control modules. This may further reduce complexity and costs. With rear functions integrated into a single unit, technicians may diagnose and repair issues more easily, accessing rear electrical systems from one point, which may significantly reduce service times and associated costs.

A Functionally Redundant Low Voltage Architecture between Vehicle Left and Right

This aspect is associated with a functionally redundant low voltage architecture between the vehicle's left side (e.g., west—ECU 20) and right side (e.g., east—ECU 10). This approach may ensure that critical functions (steering, braking, lighting, ADAS) have a complementary method of execution powered by the opposite bus. The architecture offers features that may improve vehicle performance, reliability, or safety.

The enhanced reliability may include providing redundant power sources for critical functions. Vehicle 300 may maintain essential operations even if one side experiences a failure. See FIG. 2A through FIG. 4 as an example. This may address reliability and safety of vehicle 300. Additionally, this approach allows for a reduction in power distribution cabling, which may significantly decrease wiring complexity and weight.

The elimination of components like diode ORing and fuse boxes (note e-fuses may remain) may reduce overall system cost. These components, while necessary in traditional architectures, add complexity and potential points of failure. Furthermore, the architecture allows for flexible power management. The power source can be selective to various endpoints depending on drive mode or failure mode. This flexibility can be leveraged to optimize power usage and extend battery life.

The improved fault tolerance may include redundant power sources. Vehicle 300 can continue to operate safely even in the event of significant electrical system damage. This may be crucial in maintaining vehicle control in accident scenarios. The left-right redundancy also allows for simplified diagnostics. If a function fails on one side but not the other, it quickly narrows down the potential source of the problem.

This functionally redundant architecture represents a departure from traditional automotive electrical systems. By creating two independent but interconnected power networks, vehicle 300 may gain a level of resilience to electrical faults. In low-power situations (such as when the battery is nearly depleted), vehicle 300 may selectively power down non-critical systems on one side while maintaining full functionality on the other, effectively extending its operating range. In an example, if there is a crash of vehicle 300 in which the DCDC 50 is unable to route power, LV battery 60 may route power through fault isolation system 11 to operate left side functions, such as left door latches. This points out that there is not just a DCDC 50 only feed and a LV battery 60 only feed (e.g., dedicated LV battery 60 wiring), but there is a shared power feed in which ECU 30 may determine where to send LV battery 60 or DCDC 50.

### DCFC Split Contactor Control for Safety

The DCFC Split Contactor Control system may address the challenge of safely connecting an external power source to a high-voltage battery pack 310 of vehicle 300. This may be particularly relevant for vehicles 300 using the North American Charging Standard (NACS), which shares AC pins with DC Fast Charging (DCFC). A split contactor control system may divide the decision-making process for enabling contactors between two microcontroller units (e.g., MCU 65 and MCU 66) of ECU 30.

This system may enhance safety by requiring agreement between two separate MCUs, reducing the risk of unsafe contactor engagement. This dual-verification process may provide an additional layer of protection when dealing with the high voltages involved in DC fast charging. Moreover, the approach helps meet Automotive Safety Integrity Level (ASIL) requirements, aligning with the principles of functional safety in automotive systems.

The system 100 can intelligently decide whether to connect the external power source directly to the battery pack for DCFC or to the On-Board Charger (OBC) for AC-DC conversion. This flexibility allows for optimal charging in various scenarios. If any one of the MCUs (e.g., MCU 65) fails or detects an issue, the system can prevent charging, ensuring that it only occurs when safe to do so. Additionally, the split control system can be updated via software to accommodate new charging standards or safety protocols.

Before engaging the main charging contactors, both MCUs (e.g., MCU 65 and MCU 66) should independently verify multiple conditions, such as the correct type of charger connection, the battery's state, the absence of fault conditions, or proper pre-charge circuit operation. Only when both MCUs agree that the threshold conditions are met will the system 100 allow the main contactors to close and charging to begin. During the charging process, both MCUs may continuously monitor various parameters, with each MCU capable of immediately opening the contactors if an issue is detected.

The ability to distinguish between AC and DC charging and route power appropriately may be valuable in the context of the North American Charging Standard. This flexibility allows vehicle 300 to make efficient use of available charging infrastructure, from home AC chargers to high-power DC fast charging stations.

During normal driving conditions, the system may manage power distribution, ensure optimal power routing, or control both high voltage and critical low voltage functions. In the event of a side impact, the system can quickly isolate the affected area, reallocate power, or adapt vehicle functions as needed.

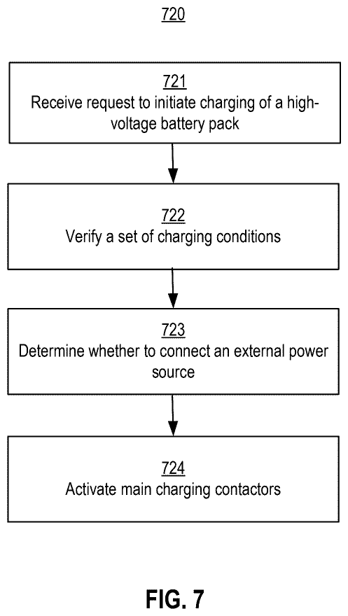

FIG. 7 illustrates an example method 720 for implementing split contactor control in an electric vehicle as disclosed herein. At step 721, a request to initiate charging of a high-voltage battery pack may be received.

At step 722, a set of charging conditions may be independently verified by a first microcontroller unit (MCU) 66 and a second MCU 65 of an electronic control unit (ECU) 30. The set of charging conditions may include verifying that a correct type of charger is connected, confirming the high-voltage battery pack 310 is in a state to accept charge, checking for the absence of fault conditions in the battery pack and charging system, and verifying that a pre-charge circuit has properly balanced voltages.

At step 723, the first MCU 65 and the second MCU 66 may determine whether to connect an external power source to the high-voltage battery pack 310 based on the verified charging conditions. At step 724, the main charging contactors may be enabled only when both the first MCU 65 and the second MCU 66 agree that threshold charging conditions are met.

Charging parameters may be continuously monitored during the charging process. It is also contemplated herein that if an issue is detected by one of the MCUs during the charging process, the method may immediately open the main charging contactors in response to the detected issue.

The method may distinguish between alternating current (AC) and direct current (DC) charging. Power may be routed appropriately based on the distinguished charging type. Routing power appropriately may include connecting the external power source directly to the high-voltage battery pack for DC fast charging or connecting the external power source to an on-board charger for AC-DC conversion.

The split contactor control system may be updated via software to accommodate new charging standards or safety protocols. This may ensure that the system remains adaptable to evolving technologies and requirements.

The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone specific electronic control units (ECUs). The information (e.g., voltage, current, resistance, or proposed functionality), as disclosed herein in the figures and text, is provided for illustrative purposes and other scenarios are contemplated herein.

Methods, systems, and apparatus with regard to centralized power management in a vehicle are disclosed herein. A power management compartment of a vehicle may include a high-voltage battery pack; a DC-DC converter; a LV battery; a zonal controller integrating BMS functionality; and a power distribution unit. The centralized power module distributes power to front zones of the vehicle through separate left and right power paths. The centralized power module may be located in a rear of the vehicle. The LV battery may be directly connected to the zonal controller for voltage and current monitoring. The compartment may further comprise an adaptive power routing system configured to detect faults in the power distribution; reconfigure power routing to maintain critical functions in response to detected faults; or selectively shed non-critical loads to ensure sufficient power for essential systems. Critical vehicle functions may be split between components powered by the left power path and components powered by the right power path to provide functional redundancy. The centralized power module may be located under a second row seat of the vehicle or in a crash protected zone. Critical loads are electrical systems and components considered essential for basic vehicle safety, operation, and control. These typically include steering systems, braking systems, lighting (especially headlights and brake lights), safety-critical sensors and controllers, battery management systems, communication networks for essential vehicle functions, airbag and occupant safety systems, or emergency notification systems. These systems may maintain power during fault conditions to ensure vehicle safety and basic functionality. All combinations (including the removal or addition of features) in this paragraph are contemplated in a manner that is consistent with the other portions of the detailed description.

Methods, systems, and apparatus with regard to split contactor control in an electric vehicle are disclosed herein. A method for implementing split contactor control in an electric vehicle may include receiving a request to initiate charging of a high-voltage battery pack; verifying, by a first microcontroller unit (MCU) and a second MCU of an electronic control unit (ECU), a set of charging conditions; determining, by the first MCU and the second MCU, whether to connect an external power source to the high-voltage battery pack based on the verified charging conditions; and enabling main charging contactors when both the first MCU and the second MCU agree that charging conditions are met. The set of charging conditions may include verifying a correct type of charger is connected; confirming the high-voltage battery pack is in a state to accept charge; checking for absence of fault conditions in the battery pack and charging system; or verifying a pre-charge circuit has properly balanced voltages. The method may further include detecting an issue by one of the MCUs during the charging process; and opening the main charging contactors in response to the detected issue. The method may further include distinguishing between alternating current (AC) and direct current (DC) charging; or routing power based on the distinguished charging type. Routing power appropriately may include connecting the external power source directly to the high-voltage battery pack for DC fast charging; or connecting the external power source to an on-board charger for AC-DC conversion. The method may further include updating the split contactor control system via software to accommodate new charging standards or safety protocols. All combinations (including the removal or addition of steps) in this paragraph are contemplated in a manner that is consistent with the other portions of the detailed description.

A system for split contactor control in an electric vehicle may include a high-voltage battery pack; main charging contactors; an electronic control unit (ECU) comprising a first microcontroller unit (MCU) and a second MCU; and a memory storing instructions that, when executed by the ECU, cause the system to perform operations comprising: receiving a request to initiate charging of the high-voltage battery pack; verifying, by the first MCU and the second MCU, a set of charging conditions; determining, by the first MCU and the second MCU, whether to connect an external power source to the high-voltage battery pack based on the verified charging conditions; or enabling the main charging contactors when both the first MCU and the second MCU agree that charging conditions are met. All combinations (including the removal or addition of components) in this paragraph are contemplated in a manner that is consistent with the other portions of the detailed description.

A device for implementing split contactor control in an electric vehicle may include one or more processors configured to: receive a request to initiate charging of a high-voltage battery pack; verify, by a first microcontroller unit (MCU) and a second MCU of an electronic control unit (ECU), a set of charging conditions; determine, by the first MCU and the second MCU, whether to connect an external power source to the high-voltage battery pack based on the verified charging conditions; and enable main charging contactors when both the first MCU and the second MCU agree that charging conditions are met. The set of charging conditions may include verifying a correct type of charger is connected; confirming the high-voltage battery pack is in a state to accept charge; checking for absence of fault conditions in the battery pack and charging system; or verifying a pre-charge circuit has properly balanced voltages. The one or more processors may be further configured to detect an issue by one of the MCUs during the charging process; and open the main charging contactors in response to the detected issue. The one or more processors may be further configured to distinguish between alternating current (AC) and direct current (DC) charging; and route power based on the distinguished charging type. All combinations (including the removal or addition of features) in this paragraph are contemplated in a manner that is consistent with the other portions of the detailed description.

The term “or” is used inclusively unless otherwise disclosed. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A power management compartment of a vehicle, the power management compartment comprising:
a high-voltage battery pack;
a direct current to direct current converter;
a low voltage battery;
a electronic control unit configured to integrate battery management system functionality; and
a power distribution unit, wherein the power distribution unit distributes power to front zones of the vehicle through separate power paths.

2. The power management compartment of claim 1, wherein the power management compartment is located at a rear of the vehicle.

3. The power management compartment of claim 1, wherein the low voltage battery is directly connected to the electronic control unit for voltage and current monitoring.

4. The power management compartment of claim 1, further comprising an adaptive power routing system configured to:
detect faults in the power distribution unit;
reconfigure power routing to maintain critical functions in response to detected faults; or
selectively shed non-critical loads to ensure sufficient power for essential systems.

5. The power management compartment of claim 1, wherein critical vehicle functions are split between components powered by a left power path and components powered by a right power path to provide functional redundancy.

6. The power management compartment of claim 1, wherein the power management compartment is located under a second row seat of the vehicle or in a crash protected zone.

7. The power management compartment of claim 1, wherein the low voltage battery has voltage in a range of 9 volts to 16 volts.

8. A method of implementing split contactor control in an electric vehicle, comprising:
receiving a request to initiate charging of a high-voltage battery pack;
verifying, by a first microcontroller unit (MCU) and a second MCU of an electronic control unit (ECU), a set of charging conditions;
determining, by the first MCU and the second MCU, whether to connect an external power source to the high-voltage battery pack based on the verified charging conditions; and
enabling main charging contactors when the first MCU and the second MCU confirm that charging conditions are met.

9. The method of claim 8, wherein the set of charging conditions comprises:
verifying a correct type of charger is connected;
confirming the high-voltage battery pack is in a state to accept charge;
checking for absence of fault conditions in the battery pack and charging system; and
verifying a pre-charge circuit has properly balanced voltages.

10. The method of claim 8, further comprising:
detecting an issue by one of the first MCU or the second MCU during a charging process; and
opening the main charging contactors in response to the detected issue.

11. The method of claim 8, further comprising:
distinguishing a charging type between alternating current (AC) charging and direct current (DC) charging; and
routing power based on the charging type.

12. The method of claim 11, wherein routing the power comprises connecting the external power source directly to the high-voltage battery pack for DC fast charging.

13. The method of claim 11, wherein routing the power comprises connecting the external power source to an on-board charger for AC-DC conversion.

14. The method of claim 8, further comprising updating a split contactor control system via software to accommodate new charging standards or safety protocols.

15. A device for implementing split contactor control in an electric vehicle, the device comprising:
one or more processors configured to:
receive a request to initiate charging of a high-voltage battery pack;
verify, by a first microcontroller unit (MCU) and a second MCU of an electronic control unit (ECU), a set of charging conditions;
determine, by the first MCU and the second MCU, whether to connect an external power source to the high-voltage battery pack based on the verified set of charging conditions; and
enable main charging contactors when both the first MCU and the second MCU confirm that charging conditions are met.

16. The device of claim 15, wherein the one or more processors configured to verify the set of charging conditions are further configured to:
verify a correct type of charger is connected;
confirm the high-voltage battery pack is in a state to accept charge;
check for absence of fault conditions in the battery pack and charging system; and
verify a pre-charge circuit has properly balanced voltages.

17. The device of claim 15, wherein the one or more processors are further configured to:
detect an issue by one of the first MCU or the second MCU during a charging process; and
open the main charging contactors in response to the detected issue.

18. The device of claim 15, wherein the one or more processors are further configured to:
distinguish a charging type between alternating current (AC) charging and direct current (DC) charging; and
route power based on the charging type.

19. The device of claim 18, wherein routing power appropriately comprises connecting the external power source directly to the high-voltage battery pack for DC fast charging.

20. The device of claim 18, wherein routing power appropriately comprises connecting the external power source to an on-board charger for AC-DC conversion.
